(19) United States
(12) Patent Application Publication
(10) Pub. No.: US 2014/0218614 A1
(43) Pub. Date: Aug. 7, 2014

(54) MULTI-SIGNAL TRANSMITTER MODULE, MULTI-SIGNAL RECEIVER MODULE, AND DEVICE FOR CONTROLLING AND INTEGRATING MULTIPLE TYPES OF SIGNAL TRANSMISSION CABLES

(71) Applicants: Chih-Chun Ho, New Taipei City (TW); Chih-Yuan Ho, New Taipei City (TW); Szuyu Ho, New Taipei City (TW); Hui-Ming Ho, New Taipei City (TW)

(72) Inventors: Chih-Chun Ho, New Taipei City (TW); Chih-Yuan Ho, New Taipei City (TW); Szuyu Ho, New Taipei City (TW); Hui-Ming Ho, New Taipei City (TW)

(73) Assignee: ABA ELECTRONICS TECHNOLOGY CO., LTD., New Taipei City (TW)

(21) Appl. No.: 13/760,064

(22) Filed: Feb. 6, 2013

(51) Int. Cl. H04N 7/10

(52) U.S. Cl. CPC H04N 7/10
USPC 348/720

(57) ABSTRACT

A device for controlling and integrating multiple types of signal transmission cables includes a multi-signal transmitter module and a multi-signal receiver module. The multi-signal receiver module is connected to the multi-signal transmitter module via a network cable for receiving a first and a second differential signal sequentially transmitted by the multi-signal transmitter module. The multi-signal receiver module also performs a differential solution process for the received first and second differential signals, so as to get a first control instruction and a video signal, which are then sequentially transmitted to at least one electronic device for the same to execute a corresponding operation. With these arrangements, multiple signals can be transmitted and received with reduced quantity of cables, and the controlling and integrating device can be installed and maintained with reduced labor cost.

This application claims the priority benefit of Taiwan patent application number 101219917 filed on Oct. 16, 2012.

### FIELD OF THE INVENTION

The present invention relates to a transmitter module, a receiver module and a controlling and integrating device; and more particularly, to a device for controlling and integrating multiple types of signal transmission cables that includes a multi-signal transmitter module and a multi-signal receiver module connected to each other via one single network cable to enable easy installation and maintenance at reduced cost and avoid the problem of delayed or asynchronous signals.

### BACKGROUND OF THE INVENTION

Thanks to the progress and development in the technological fields, various kinds of electronic devices, such as projectors, computers, television sets, electronic signboards and the like, have been widely used in many public spaces, such as conference rooms, shopping centers, rapid transit stations, airports and the like, and in many teaching places, such as classrooms and auditoriums.

Please refer to FIG. 1A. Currently, for example, most classrooms have been equipped with a plurality of electronic devices 10, such as projector, television and display screen. These electronic devices 10 are connected via different types of signal transmission cables 11, such as VIDEO, S/V, YUV, VGA, HDMI and DisplayPort cables, to VIDEO, S/V, YUV, VGA, HDMI and DisplayPort signal connection ports on an audio/visual (AV) connection box 121 in a central control device 12. To use any of the electronic devices 10, such as a projector, a liquid crystal display (LCD) screen or the like, a user can operate on a user interface connected to the central control device 12 to push buttons for turning on the projector and switch the same to a desired signal mode. When the central control device 12 receives the turn-on signal and the signal-mode switch signal, it transmits a turn-on instruction and a signal-mode switch instruction to the projector via an RS232 or an infrared (IR) remote control unit, so that the projector is turned on and switched to a selected one of the VIDEO, S/V, YUV, VGA, HDMI and DisplayPort signal modes for performing a corresponding operation.

FIG. 1B shows more details of the central control device 12 in FIG. 1A. As shown, the conventional AV connection box 121 is internally provided with a plurality of signal switches 14 for different VIDEO, S/V, YUV, VGA, HDMI and DisplayPort connection ports, so as to enable convenient switching among multiple signal modes, such as VIDEO, S/V, YUV, VGA, HDMI and DisplayPort signal modes. Each of the signal switches 14 includes a set of similar signal connection ports. For example, FIG. 1B shows that the VIDEO switch 14 internally includes two VIDEO signal connection ports. Meanwhile, each signal switch 14 is connected to one corresponding electronic device 10 via a signal transmission cable 11. Therefore, via the signal switches 14, the central control device 12 can conveniently switch among multiple signal modes.

While the conventional central control device 12 can conveniently control different electronic devices 10 to operate, there is a large number of complicated signal transmission cables included in the conduit extended to between the central control device 12 and the electronic devices 10 because the VIDEO, S/V, YUV, VGA, HDMI and DisplayPort signal connection ports on the AV connection box 121 of the central control device 12 are connected to the corresponding electronic devices 10 in one-to-one correspondence. It is possible a certain signal transmission cable in the conduit is damaged, or other new signal transmission cables, such as HDMI, DVI and DisplayPort cables are to be added, or the wiring in the conduit must be changed. Such repairing or maintenance works could not be easily done by general users but require professionals to complete them. Therefore, the connection system between the conventional central control device and different electronic devices is complicated that requires high cost and could not be easily installed, maintained or replaced by general users.

In brief, the prior art has the following disadvantages: (1) the central control device is connected to the electronic devices via a large number of signal transmission cables to result in increased material cost; (2) the maintenance of the connection system between the central control device and the electronic devices must be done by professionals; and (3) the connection system between the central control device and the electronic devices could not be easily installed and maintained to cause inconvenience in use.

It is therefore tried by the inventor to develop a multi-signal transmitter module, a multi-signal receiver module and a device for controlling and integrating multiple types of signal transmission cables in an attempt of overcoming the disadvantages in the prior art.

### SUMMARY OF THE INVENTION

A primary object of the present invention is to provide a multi-signal transmitter module that saves a lot of cable material cost and can be easily installed.

Another object of the present invention is to provide a multi-signal transmitter module that does not require complicated procedures for analog-to-digital (A/D) conversion, digital-to-analog (D/A) conversion, encoding or decoding to thereby avoid the problem of delayed or asynchronous signals.

A further object of the present invention is to provide a multi-signal receiver module that saves a lot of cable material cost and can be easily installed.

A still further object of the present invention is to provide a multi-signal receiver module that does not require complicated procedures for analog-to-digital (A/D) conversion, digital-to-analog (D/A) conversion, encoding or decoding to thereby avoid the problem of delayed or asynchronous signals.

A still further object of the present invention is to provide a device for controlling and integrating multiple types of signal transmission cables that saves a lot of cable material cost and can be easily installed.

A still further object of the present invention is to provide a device for controlling and integrating multiple types of signal transmission cables that does not require complicated procedures for analog-to-digital (A/D) conversion, digital-to-analog (D/A) conversion, encoding or decoding to thereby avoid the problem of delayed or asynchronous signals.

To achieve the above and other objects, the multi-signal transmitter module according to the present invention includes a first signal source unit for receiving a plurality of video signals, a selection interface unit, a control unit, a signal selection unit and a differential conversion unit. The selection interface unit is provided for a user to select a function to be executed and generates a selection signal to the control unit when a function is selected. The control unit is connected with the selection interface unit and generates a first control instruction and a second control instruction according and corresponding to the received selection signal. The signal selection unit includes at least one RS232 position and a plurality of video positions. The RS232 position is connected to the control unit and allows the first control instruction to transmit therethrough. The video positions are connected to the first signal source unit and the control unit, and any one of the video positions can be enabled according to the second control instruction, so that one of the video signals that corresponds to the enabled video position can pass the signal selection unit.

The differential conversion unit is connected to the signal selection unit to generate a first differential signal according to the first control instruction and generate a second differential signal according to the second control instruction. The first and the second differential signal are then sequentially received by a multi-signal receiver module. The multi-signal transmitter module of the present invention not only enables reduced cost and is easy to mount, but also effectively avoids the problem of delayed or asynchronous video signals.

To achieve the above and other objects, the multi-signal receiver module according to the present invention receives a first differential signal and a second differential signal sequentially transmitted by a multi-signal transmitter module via a network cable, and includes a differential solution unit and a signal distribution unit. The differential solution unit is connected to the signal distribution unit and performs a differential solution process for the sequentially received first and second differential signals, so as to get a first control instruction and a video signal. The signal distribution unit is connected to at least one electronic device and transmits the first control instruction and the video signal to one corresponding electronic device for the latter to execute a corresponding operation. The multi-signal receiver module of the present invention not only enables reduced cost and is easy to mount, but also effectively avoids the problem of delayed or asynchronous video signals.

To achieve the above and other objects, the device for controlling and integrating multiple types of signal transmission cables according to the present invention includes a multi-signal transmitter module and multi-signal receiver module. The multi-signal transmitter module includes a first signal source unit for receiving a plurality of video signals, a selection interface unit, a control unit, a signal selection unit and a differential conversion unit. The selection interface unit is provided for a user to select a function to be executed and generates a selection signal to the control unit when a function is selected. The control unit is connected with the selection interface unit and generates a first control instruction and a second control instruction according and corresponding to the received selection signal. The signal selection unit includes at least one RS232 position and a plurality of video positions. The RS232 position is connected to the control unit and allows the first control instruction to transmit therethrough. The video positions are connected to the first signal source unit and the control unit, and any one of the video positions can be enabled according to the second control instruction, so that one of the video signals that corresponds to the enabled video position can pass the signal selection unit.

The differential conversion unit is connected to an end of a network cable and the signal selection unit to generate a first differential signal according to the first control instruction and generate a second differential signal according to the second control instruction. The multi-signal receiver module is connected to another end of the network cable and includes a differential solution unit and a signal distribution unit. The differential solution unit is connected to the signal distribution unit and performs a differential solution process for the first and second differential signals sequentially received from the multi-signal transmitter module, so as to get the first control instruction and a video signal selected by the second control instruction. The signal distribution unit is connected to at least one electronic device and transmits the first control instruction and the video signal selected by the second control instruction to one corresponding electronic device for the latter to execute a corresponding operation. By combining the multi-signal transmitter module with the multi-signal receiver module, the controlling and integrating device of the present invention not only enables reduced cost and is easy to mount, but also effectively avoids the problem of delayed or asynchronous video signals.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a general block diagram showing the connection system between a central control device and multiple electronic devices via a plurality of signal transmission cables;

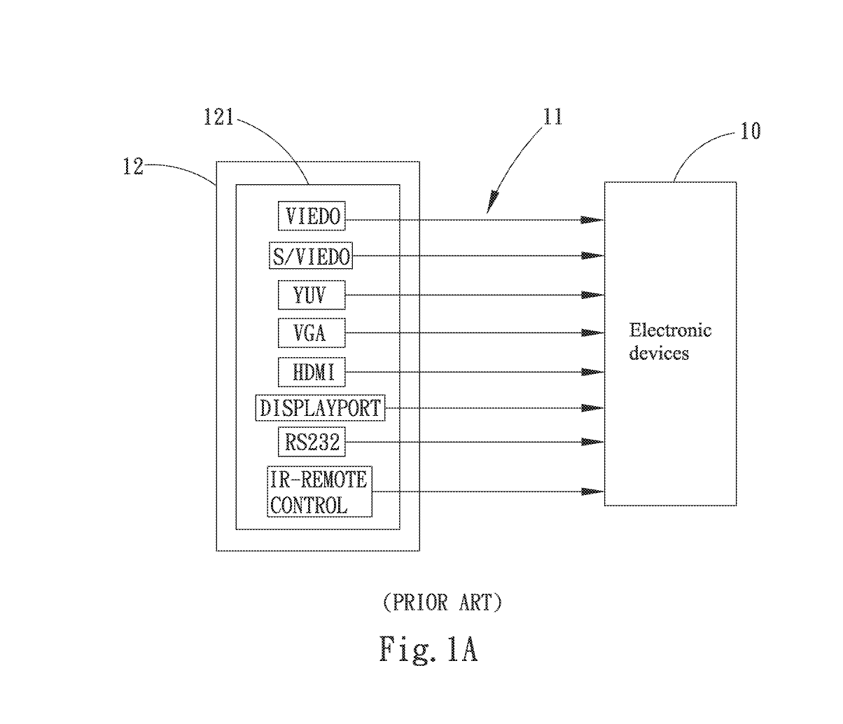

FIG. 1B shows more details of FIG. 1A;

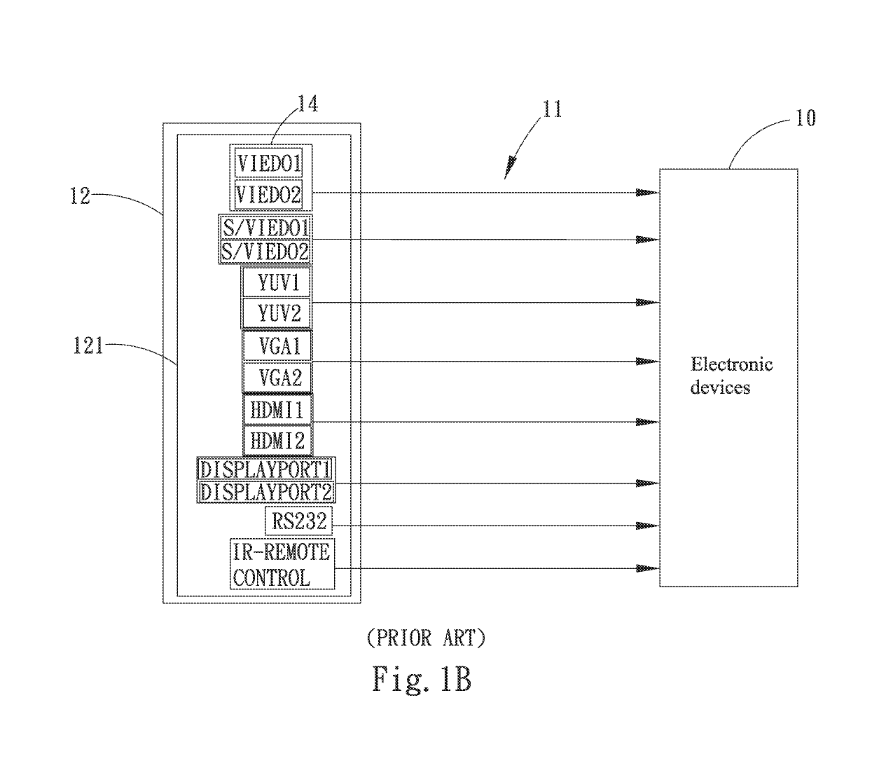

FIG. 2 is a general block diagram of a device for controlling and integrating multiple types of signal transmission cables according to a first preferred embodiment of the present invention;

FIG. 3 shows more details of FIG. 2;

FIG. 4 is a general block diagram of a device for controlling and integrating multiple types of signal transmission cables according to a second preferred embodiment of the present invention; and

FIG. 5 shows more details of FIG. 4.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

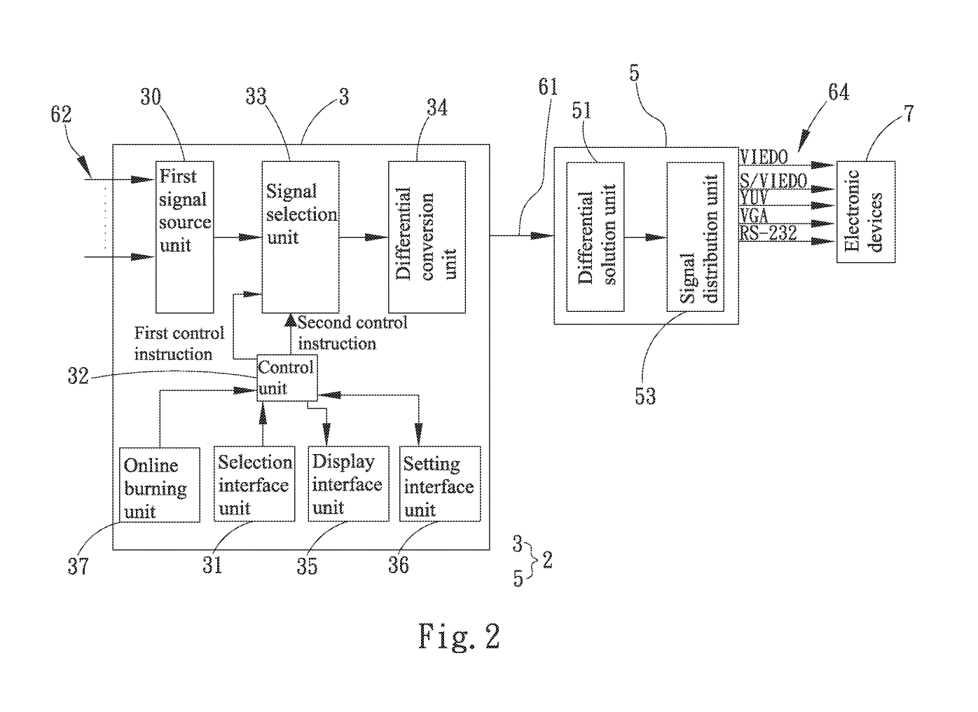

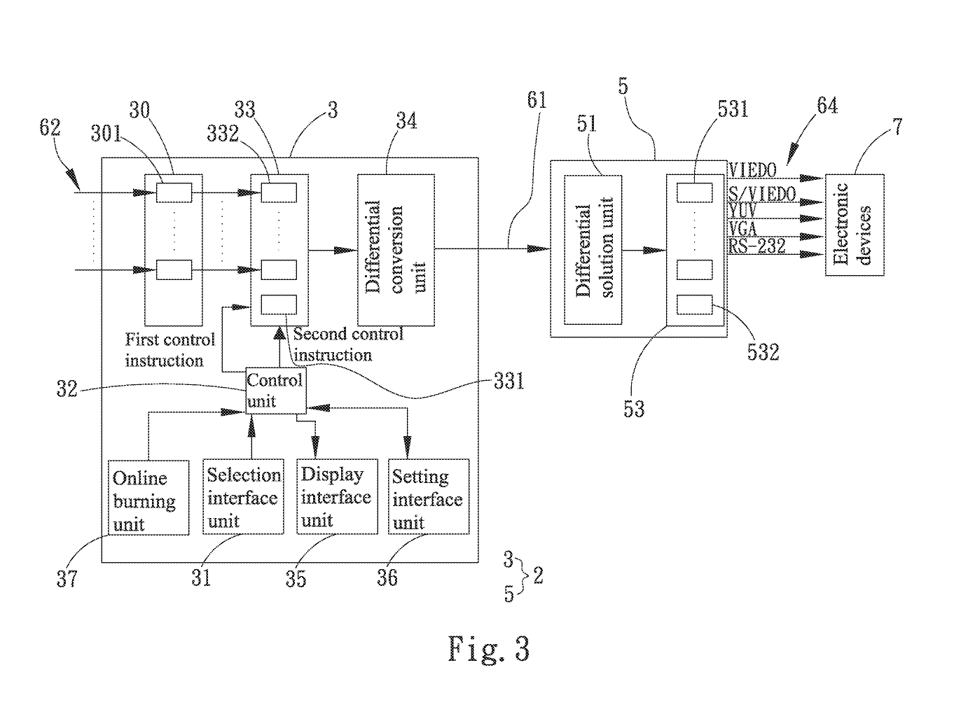

Please refer to FIGS. 2 and 3 that are general and detailed block diagrams, respectively, of a device for controlling and integrating multiple types of signal transmission cables according to a first preferred embodiment of the present invention. For the purpose of conciseness and clarity, the device according to the present invention is also briefly referred to as the controlling and integrating device herein and is generally denoted by reference numeral 2. As shown in FIGS. 2 and 3, the controlling and integrating device 2 in the first embodiment includes a multi-signal transmitter module 3 and a multi-signal receiver module 5. The multi-signal transmitter module 3 is connected to the multi-signal receiver module 5 via a network cable 61; and the multi-signal receiver module 5 is connected to a plurality of different electronic devices 7 via a plurality of short cables 64 of different formats, such as VIDEO, S/VIDEO, VGA and RS232 cables. The electronic devices 7 can include, but not limited to, a projector, a television set, a display, such as an LED display or an LCD display, and an audio/video player. While the network cable 61 is described as a CAT5 cable herein, it is understood the present invention is not restricted thereto and the network cable 61 can be otherwise a CAT5e, a CAT6, a CAT7 or a CAT7a cable.

The multi-signal transmitter module 3 includes a first signal source unit 30, a selection interface unit 31, a control unit 32, a signal selection unit 33, a differential conversion unit 34, a display interface unit 35, a setting interface unit 36, and an online burning unit 37.

The first signal source unit 30 includes a plurality of first connection ports 301 of different formats, such as VIDEO, S/VIDEO, YUV and VGA connection ports. The first connection ports 301 are separately connected at their one ends to a plurality of first transmission cables 62 for receiving a plurality of video signals transmitted over the first transmission cables 62. While the first transmission cables 62 referred to in the first preferred embodiment of the present invention are described as VIDEO, S/VIDEO, YUV and VGA cables, it is understood the present invention is not limited thereto. In practical implementation of the present invention, the first transmission cables 62 referred to herein may be any transmission cables capable of transmitting analog video signals. Meanwhile, all the video signals referred to herein are analog video signals.

The selection interface unit 31 is connected to the control unit 32, which can be, for example, a micro control unit (MCU), for a user to select a function to be executed by pushing one of many function keys on the selection interface unit 31. The function keys can include, but not limited to, a START key, a SHUT DOWN key, a VIDEO key, a VGA key and the like. When the user selects and pushes one of the function keys, the selection interface unit 31 correspondingly generates a selection signal to the control unit 32. According to the selection signal received from the selection interface unit 31, the control unit 32 correspondingly generates a first control instruction and a second control instruction. The first control instruction is an RS232 instruction and matches the selection signal. For instance, when the selection signal is to enable a VIDEO function, the matching RS232 instruction is then used to control a corresponding electronic device 7 to switch to a VIDEO mode.

The signal selection unit 33 includes a plurality of video positions 332 and one RS232 position 331. The RS232 position 331 is connected to the control unit 32 and allows the first control instruction to transmit therethrough. The video positions 332 include, for example, a VIDEO position, an S/VIDEO position, a YUV position and a VGA position, and are connected to the first signal source unit 30 and the control unit 32. In other words, the video positions 332 are correspondingly connected to another ends of the first connection ports 301 and to the control unit 32. Any one of the video positions 332 can be enabled according to the second control instruction transmitted by the control unit 32, so that a video signal corresponding to the enabled video position 332 can pass the signal selection unit 33. For instance, when the selection signal is to start the VIDEO function, the control unit 32 will then, according to the selection signal, generate a second control instruction for immediately start or enable one VIDEO position among the plurality of video positions 332 in the signal selection unit 33. At this point, the video signal over one of the first connection ports 301 that is connected to the enabled VIDEO position can pass the enabled VIDEO position. Here, the video positions 332 and the RS232 position 331 work like switches. For instance, the RS232 position 331 is switched on or turned on when the first control instruction is received, and any one of the video positions 332 can be switched on or turned on when a second control instruction is received.

As can be seen in FIG. 2, the differential conversion unit 34 is connected to a first end of the network cable 61 and to the signal selection unit 33 for generating a first differential signal according to the first control instruction and generating a second differential signal according to the video signal selected by the second control instruction. In other words, the differential conversion unit 34 first converts the received first control instruction into a first differential signal and transmits the same to the multi-signal receiver module 5 via the network cable 61; and then converts the video signal selected by the second control instruction into a second differential signal and transmits the same to the multi-signal receiver module 5 via the network cable 61.

The display interface unit 35 is connected to the control unit 32 for displaying the function selected by the user. The control unit 32, according to the VIDEO function corresponding to the selection signal, generates a display signal for controlling the display interface unit 35 to lighten a VIDEO lamp. While the display interface unit 35 in the first preferred embodiment is described as showing the selected video function by a lamp, it is understood the present invention is not limited thereto. In practical implementation of the present invention, the display interface unit 35 can be differently designed to indicate the selected function by words or by different number of times of flashing of a lamp.

The setting interface unit 36 and the online burning unit 37 with an in-system programming (ISP) ability are respectively connected to the control unit 32. The setting interface unit 36 is used to set the on/off time for each of the electronic devices 7. For instance, the user may use the setting interface unit 36 to set a warm-up time after start or a cooling time after shut-down for a selected electronic device 7, such as a projector. The online burning unit 37 is used to update instruction data in the control unit 32 (i.e. different first control instructions). The control unit 32 has a plurality of first control instructions previously burned and stored therein. When it is desired to update any of the stored first control instructions, the user may burn the new first control instruction into the control unit 32 via the online burning unit 37, so as to update the instruction data in the control unit 32.

The multi-signal receiver module 5 is connected to an opposite second end of the network cable 61, and includes a differential solution unit 51 and a signal distribution unit 53. The differential solution unit 51 is connected to the signal distribution unit 53, and performs a differential solution process for the first and the second differential signal according to the order in which these signals are received, so as to get the first control instruction and the video signal selected by the second control instruction and transmit them to the signal distribution unit 53.

The signal distribution unit 53 is connected to the electronic devices 7, and is internally provided with at least one RS232 connection port 532 and a plurality of video connection ports 531 of different formats, such as VIDEO, S/VIDEO, YUV and VGA connection ports. The video connection ports 531 are connected to corresponding electronic devices 7 via short cables 64. The signal distribution unit 53 distributes the video signal (such as a VIDEO signal) selected by the second control instruction transmitted by the differential solution unit 51 to one of the video connection ports 531, such as a VIDEO connection port, that matches the selected video signal, so that the selected video signal passes the distributed video connection port 531 and is transmitted to the corresponding electronic device 7 for displaying.

The RS232 connection port 532 of the signal distribution unit 53 is connected via one short cable, which is an RS232 cable, to an RS232 connection port on the corresponding electronic device 7. Therefore, the signal distribution unit 53 can distribute the received first control instruction to the RS232 connection port 532 therein, so that the first control instruction passes the RS232 connection port 532 and is transmitted to the corresponding electronic device 7, such as a projector, for the latter to perform a corresponding operation, such as switching to the VIDEO mode. Thereafter, the signal distribution unit 53 will distribute the video signal (such as a VIDEO signal) selected by the received second control instruction to a corresponding video connection port 531, such as a VIDEO connection port, so that the selected video signal passes the corresponding video connection port 531 and is transmitted to the corresponding electronic device 7, such as a projector, for the latter to perform a corresponding operation, such as playing the video signal.

The first preferred embodiment of the controlling and integrating device 2 of the present invention is now described with an example in more details. In this example, the corresponding electronic device 7 is a projector.

Please refer to FIGS. 2 and 3 again. When a user pushes a “START” key on the selection interface unit 31, a selection signal is generated and transmitted by the selection interface unit 31 to the control unit 32. According to the received selection signal, the control unit 32 correspondingly generates a first control instruction that was previously burned into the control unit 32 (i.e. a START instruction among the RS232 instructions). The first control instruction is transmitted to the signal selection unit 33 for the latter to switch to the RS232 position 331 therein, via which the first control instruction passes and is transmitted to the differential conversion unit 34. The differential conversion unit 34 converts the received first control instruction into a first differential signal, which is transmitted via the network cable 61 to the multi-signal receiver module 5. The differential solution unit 51 of the multi-signal receiver module 5 performs a differential solution process for the received first differential signal, so as to get the first control instruction and transmit the same to the signal distribution unit 53. Then, the signal distribution unit 53 distributes the received first control instruction to the RS232 connection port 532 therein, so that the first control instruction passes the RS232 connection port 532 and is transmitted to the projector 7. At this point, the projector 7 starts according to the first control instruction. In addition, since the started projector 7 requires a period of warm-up time, the user may use the setting interface unit 36 to set the warm-up time for the projector 7.

Then, the user may further push a “VIDEO” key on the selection interface unit 31. At this point, according to the selection signal generated and transmitted by the selection interface unit 31, the control unit 32 will correspondingly generate a first control instruction that was previously burned into the control unit 32 (i.e. a VIDEO instruction among the RS232 instructions). The first control instruction is transmitted to the signal selection unit 33. Meanwhile, the control unit 32 also transmits a display signal for controlling the display interface unit 35 to lighten the VIDEO lamp thereof. On receipt of the first control instruction, the signal selection unit 33 is switched to the RS232 position 331 therein, via which the first control instruction passes and is transmitted to the differential conversion unit 34. The differential conversion unit 34 converts the received first control instruction into a first differential signal, which is transmitted via the network cable 61 to the multi-signal receiver module 5. The differential solution unit 51 of the multi-signal receiver module 5 performs a differential solution process for the received first differential signal, so as to get the first control instruction and transmit the same to the signal distribution unit 53. Then, the signal distribution unit 53 distributes the received first control instruction to the RS232 connection port 532 therein, so that the first control instruction passes the RS232 connection port 532 and is transmitted to the projector 7. At this point, the projector 7 is switched to the VIDEO mode according to the first control instruction.

Thereafter, the control unit 32 will, according to the received selection signal, correspondingly generate a second control instruction to the signal selection unit 33, so as to select and enable a VIDEO position among the plurality of video positions 332 in the signal selection unit 33, i.e. to switch the signal selection unit 33 to the VIDEO position thereof. Therefore, the video signal (a VIDEO signal) over one of the first connection ports 301 that is correspondingly connected to the selected VIDEO position passes the VIDEO position and is transmitted to the differential conversion unit 34. The differential conversion unit 34 converts the received video signal (a VIDEO signal) into a second differential signal, which is transmitted via the network cable 61 to the multi-signal receiver module 5. The differential solution unit 51 of the multi-signal receiver module 5 performs a differential solution process for the received second differential signal, so as to get the video signal (a VIDEO signal) and transmit the same to the signal distribution unit 53. Then, the signal distribution unit 53 distributes the received video signal (a VIDEO signal) to a corresponding VIDEO connection port therein, so that the video signal passes the corresponding VIDEO connection port and is transmitted to the projector 7 for displaying or playing. With these arrangements, the controlling and integrating device 2 of the present invention can be easily installed at reduced cost.

With the present invention, the multi-signal transmitter module 3 is connected to the multi-signal receiver module 5 via only one single network cable 61 to achieve the purpose of selectively transmitting a desired video signal to a corresponding electronic device 7 for displaying or playing while controlling the electronic device 7 to execute a selected operation. That is, with the present invention, the required quantity and types of cables are effectively reduced to save a lot of material cost. Meanwhile, since the network cable 61 is easily available and can be installed and maintained by the user instead of an electronic professional, the present invention is a Plug and Play device and can be easily installed to save a lot of labor cost.

The controlling and integrating device 2 of the present invention can be used in different public spaces, such as conference rooms, shopping centers, rapid transit stations, airports and the like, and in many teaching places, such as classrooms and auditoriums. With the controlling and integrating device 2, video signals can be immediately displayed without the need of analog-to-digital (A/D) conversion or digital-to-analog (D/A) conversion or complicated encoding/decoding procedures. Further, with the controlling and integrating device 2, delayed signals or asynchronous signals can be effectively avoided.

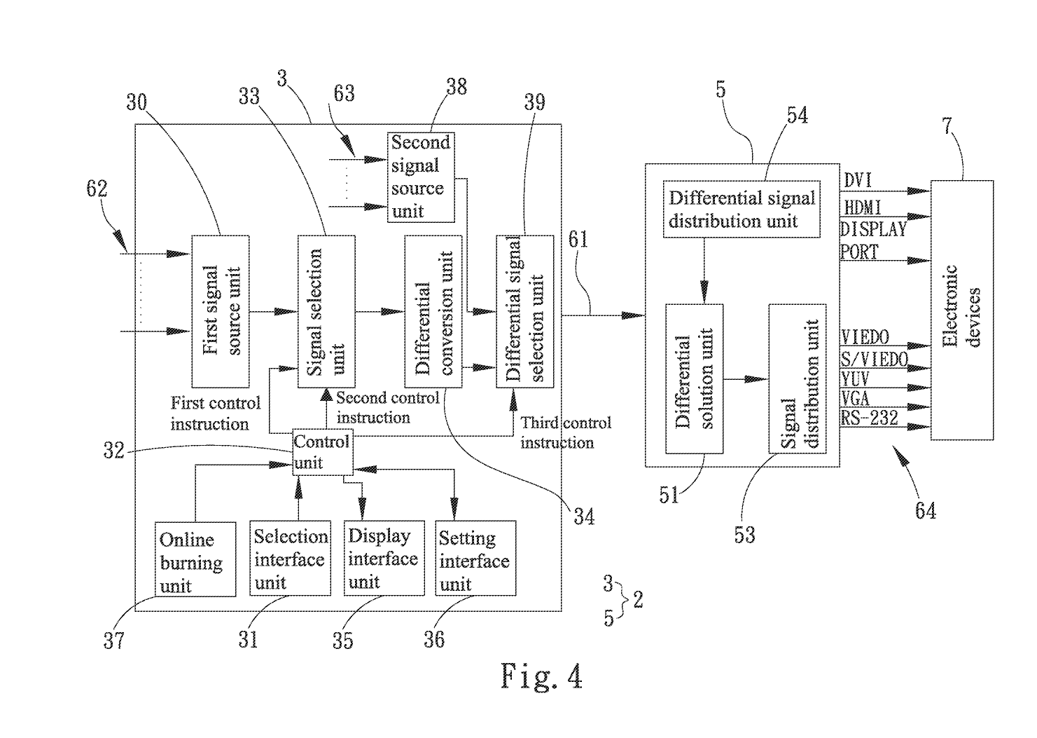

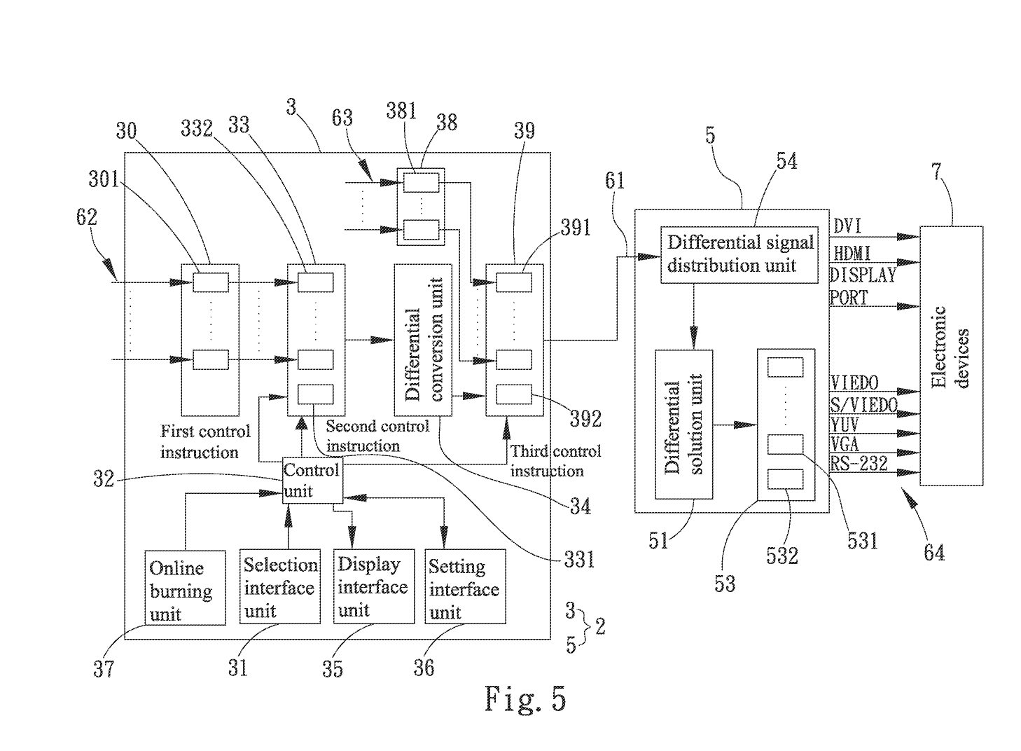

Please refer to FIGS. 4 and 5 that are general and detailed block diagrams, respectively, of a second preferred embodiment of the controlling and integrating device 2. As shown, the second embodiment is generally structurally similar to the first embodiment, except that, in the second embodiment, the multi-signal transmitter module 3 further includes a second signal source unit 38 and a differential signal selection unit 39, and the multi-signal receiver module 5 further includes a differential signal distribution unit 54.

The second signal source unit 38 includes a plurality of second connection ports 381 of different formats, such as HDMI, DVI and DisplayPort connection ports. The second connection ports 381 are correspondingly connected to a plurality of second transmission cables 63 for receiving a plurality of third differential signals transmitted over the second transmission cables 63.

While the second transmission cables 63 referred to in the second preferred embodiment of the present invention are described as HDMI, DVI and DisplayPort transmission cables, it is understood the present invention is not limited thereto. In practical implementation of the present invention, the second transmission cables 63 referred to herein may be any transmission cables capable of transmitting differential signals. In the second preferred embodiment, while the third differential signals are described as TMDS (Transition Minimized Differential Signaling) signals, it is understood the present invention is not limited thereto. That is, the third differential signals can be otherwise LVDS (Low-voltage Differential Signaling) signals.

The differential signal selection unit 39 is connected to a first end of the network cable 61 and the differential conversion unit 34, and includes a plurality of differential video positions 391 and one differential instruction position 392. The differential instruction position 392 is connected to the differential conversion unit 34 for receiving the first differential signal and allows the latter to transmit therethrough. The differential sign selection unit 39 also allows the second differential signal converted by the differential conversion unit 34 to transmit therethrough, so that the second differential signal is transmitted via the network cable 61 to the multi-signal receiver module 5. The differential signal distribution unit 54 of the multi-signal receiver module 5 then distributes the received second differential signal to the differential solution unit 51, so that the differential solution unit 51 performs a differential solution process for the second differential signal. The differential video positions 391 can include, but not limited to, HDMI, DVI and DisplayPort positions, and are connected to the second signal source unit 38. That is, the differential video positions 391 are correspondingly connected to the plurality of second connection ports 381 and to the control unit 32. Any one of the differential video positions 391 can be enabled according to a third control instruction transmitted by the control unit 32, so that a third differential signal corresponding to the enabled differential video position 391 can pass the differential signal selection unit 39.

For example, when the selection signal is to start the HDMI function, the control unit 32 will then, according to the selection signal, generate a third control instruction for immediately starting or enabling an HDMI position among the plurality of differential video positions 391 in the differential signal selection unit 39. At this point, the third differential signal (an HDMI signal) over one of the second connection ports 381 that is connected to the enabled HDMI position can pass the enabled HDMI position. Here, the differential video positions 391 and the differential instruction position 392 work as switches. For instance, the differential instruction position 392 is switched on or turned on when the first differential signal is received, and one of the differential video positions 391 is switched on or turned on when the third control instruction is received.

The differential signal distribution unit 54 of the multi-signal receiver module 5 has an end connected to an opposite second end of the network cable 61 and another end connected to the differential solution unit 51 and another corresponding electronic device 7. The differential signal distribution unit 54 is connected to corresponding electronic devices 7 via a plurality of short cables 64 of different formats, such as HDMI, DVI and DisplayPort cables.

The first differential signal and the third differential signal are sequentially received by the differential signal distribution unit 54. In other words, the differential signal distribution unit 54 first distributes the first differential signal, which is transmitted by the differential signal selection unit 39 via the network cable 61, to the differential solution unit 51, so that the differential solution unit 51 performs a differential solution process for the received first differential signal to get and transmit the first control instruction to the signal distribution unit 53. Then, the signal distribution unit 53 distributes the first control instruction to the RS232 connection port 532 thereof, so that the first control instruction passes the RS232 connection port 532 and is transmitted to a corresponding electronic device 7, such as an LCD screen, for the latter to execute a corresponding operation, such as switching to an HDMI mode. Thereafter, the differential signal distribution unit 54 immediately distributes the received third differential signal, such as an HDMI signal, directly to a corresponding electronic device 7, such as an LCD display, for the latter to execute a corresponding operation, such as playing the HDMI signal.

The second preferred embodiment of the controlling and integrating device 2 of the present invention is now described with an example in more details. In this example, the corresponding electronic devices 7 include a projector and an LCD display.

Please refer to FIGS. 4 and 5 again. When a user pushes an “HDMI” key on the selection interface unit 31, a selection signal is generated and transmitted by the selection interface unit 31 to the control unit 32. According to the received selection signal, the control unit 32 correspondingly generates a first control instruction that was previously burned into the control unit 32 (i.e. an HDMI instruction among the RS232 instructions) to the signal selection unit 33. Meanwhile, the control unit 32 also transmits a display signal for controlling the display interface unit 35 to lighten an HDMI lamp thereof. On receipt of the first control instruction, the signal selection unit 33 is switched to the RS232 position 331 therein, via which the first control instruction passes and is transmitted to the differential conversion unit 34. The differential conversion unit 34 converts the received first control instruction into a first differential signal, which is transmitted to the differential signal selection unit 39. On receipt of the first differential signal, the differential signal selection unit 39 is switched to the differential instruction position 392 therein, via which the first differential signal passes and is transmitted via the network cable 61 to the multi-signal receiver module 5. The differential signal distribution unit 54 of the multi-signal receiver module 5 distributes the received first differential signal to the differential solution unit 51, which performs a differential solution process for the received first differential signal, so as to get the first control instruction and transmit the same to the signal distribution unit 53. Then, the signal distribution unit 53 distributes the received first control instruction to the RS232 connection port 532 therein, so that the first control instruction passes the RS232 connection port 532 and is transmitted to the LCD display. At this point, the LCD display is switched to an HDMI mode according to the first control instruction.

Thereafter, the control unit 32 will, according to the received selection signal, correspondingly generate a third control instruction to the differential signal selection unit 39, so as to select and enable an HDMI position among the plurality of differential video positions 391 in the differential signal selection unit 39. That is, to switch the differential signal selection unit 39 to the HDMI position thereof. Therefore, the third differential signal (an HDMI signal) on one of the second connection ports 381 that is correspondingly connected to the selected HDMI position passes the HDMI position and is transmitted via the network cable 61 to the multi-signal receiver module 5. The differential signal distribution unit 54 of the multi-signal receiver module 5 distributes the received third differential signal, such as an HDMI signal, directly to the corresponding LCD display for the latter to execute a corresponding operation, such as playing the HDMI signal. With these arrangements, the controlling and integrating device 2 of the present invention has the advantages of effectively saving a lot of material cost and enabling easy installation to also save a lot of labor cost.

In brief, the present invention is superior to the prior art in that (1) it reduces the required quantity of cables to save material cost; (2) it is a plug-and-play device and can be easily installed and maintained by a user without the help of a professional to thereby save labor cost; and (3) it effectively avoids the problem of delayed signals or asynchronous signals.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A multi-signal transmitter module, comprising:
a first signal source unit for receiving a plurality of video signals;
a selection interface unit for a user to select a function to be executed and generating a selection signal when a function is selected;
a control unit being connected to the selection interface unit for generating a first control instruction and a second control instruction according and corresponding to the selection signal generated by the selection interface unit and received by the control unit;
a signal selection unit including at least one RS232 position and a plurality of video positions; the RS232 position being connected to the control unit and allowing the first control instruction to transmit therethrough; and the video positions being connected to the first signal source unit and the control unit, such that any one of the video positions can be enabled according to the second control instruction for one of the video signals that corresponds to the enabled video position to pass the signal selection unit; and
a differential conversion unit being connected to the signal selection unit for generating a first differential signal according to the first control instruction and generating a second differential signal according to the video signal selected by the second control instruction; and the first differential signal and the second differential signal being then sequentially received by a multi-signal receiver module.

2. The multi-signal transmitter module as claimed in claim 1, further comprising a display interface unit, a setting interface unit and an online burning unit; the control unit being connected to the display interface unit and the setting interface unit; and the online burning unit being connected to the control unit for updating instruction data in the control unit.

3. The multi-signal transmitter module as claimed in claim 1, wherein the first signal source unit includes a plurality of first connection ports; the first connection ports having their one ends correspondingly connected to a plurality of first transmission cables, and having their another ends correspondingly connected to the plurality of video positions in the signal selection unit; and the first transmission cables being used to transmit the plurality of video signals.

4. The multi-signal transmitter module as claimed in claim 3, further comprising a second signal source unit and a differential signal selection unit; the second signal source unit including a plurality of second connection ports connected to a plurality of second transmission cables for receiving a plurality of third differential signals transmitted over the second transmission cables; the differential signal selection unit being connected to an end of a network cable and including a plurality of differential video positions and one differential instruction position; the differential instruction position being connected to the differential conversion unit for receiving and allowing the first differential signal to transmit therethrough; the differential video positions being connected to the second signal source unit, such that any one of the differential video positions can be enabled according to a third control instruction transmitted by the control unit for one of the third differential signals that corresponds to the enabled differential video position to pass the differential signal selection unit; and the first differential signal and the third differential signal being then sequentially received by the multi-signal receiver module.

5. The multi-signal transmitter module as claimed in claim 4, wherein the third differential signals can be LVDS (Low-voltage Differential Signaling) signals or TMDS (Transition Minimized Differential Signaling) signals.

6. A multi-signal receiver module for receiving a first differential signal and a second differential signal sequentially transmitted thereto by a multi-signal transmitter module via a network cable, comprising:
a differential solution unit for performing a differential solution process for the sequentially received first and second differential signals, so as to get a first control instruction and a video signal; and
a signal distribution unit being connected to the differential solution unit and at least one electronic device for transmitting the first control instruction and the video signal to the electronic device, so that the electronic device executes a corresponding operation.

7. The multi-signal receiver module as claimed in claim 6, wherein the network cable is selected from the group consisting of a CAT5 cable, a CAT5e cable, a CAT6 cable, a CAT7 cable and a CAT7a cable.

8. The multi-signal receiver module as claimed in claim 6, wherein the signal distribution unit includes a plurality of video connection ports for corresponding electronic devices to connect thereto, and at least one RS232 connection port for connecting to an RS232 connection port on one corresponding electronic device via an RS232 transmission cable.

9. The multi-signal receiver module as claimed in claim 6, further comprising a differential signal distribution unit, which has an end connected to an end of the network cable and another end connected to the differential solution unit and another electronic device.

10. A device for controlling and integrating multiple types of signal transmission cables, comprising:
a multi-signal transmitter module including:
a first signal source unit for receiving a plurality of video signals;
a selection interface unit for a user to select a function to be executed and generating a selection signal when a function is selected;
a control unit being connected to the selection interface unit for generating a first control instruction and a second control instruction according and corresponding to the selection signal generated by the selection interface unit and received by the control unit;
a signal selection unit including a plurality of video positions and at least one RS232 position; the RS232 position being connected to the control unit and allowing the first control instruction to transmit therethrough; and the video positions being connected to the first signal source unit and the control unit, such that any one of the video positions can be enabled according to the second control instruction for one of the video signals that corresponds to the enabled video position to pass the signal selection unit; and
a differential conversion unit being connected to the signal selection unit for generating a first differential signal according to the first control instruction and generating a second differential signal according to the video signal selected by the second control instruction; and
a multi-signal receiver module being connected to the multi-signal transmitter module via a network cable for receiving the first differential signal and the second differential signal; the multi-signal receiver module including a differential solution unit and a signal distribution unit; the differential solution unit being connected to the signal distribution unit for performing a differential solution process for the sequentially received first and second differential signals, so as to get the first control instruction and the video signal selected by the second control instruction; and the signal distribution unit being connected to at least one electronic device for transmitting the first control instruction and the video signal selected by the second control instruction to the electronic device, so that the electronic device executes a corresponding operation.

11. The device for controlling and integrating multiple types of signal transmission cables as claimed in claim 10, wherein the multi-signal transmitter module further includes a display interface unit, a setting interface unit and an online burning unit; the control unit being connected to the display interface unit and the setting interface unit; and the online burning unit being connected to the control unit for updating instruction data in the control unit.

12. The device for controlling and integrating multiple types of signal transmission cables as claimed in claim 11, wherein the first signal source unit includes a plurality of first connection ports; the first connection ports having their one ends correspondingly connected to a plurality of first transmission cables, and having their another ends correspondingly connected to the plurality of video positions in the signal selection unit; and the first transmission cables being used to transmit the plurality of video signals.

13. The device for controlling and integrating multiple types of signal transmission cables as claimed in claim 10, wherein the network cable is selected from the group consisting of a CAT5 cable, a CAT5e cable, a CAT6 cable, a CAT7 cable and a CAT7a cable.

14. The device for controlling and integrating multiple types of signal transmission cables as claimed in claim 10, wherein the signal distribution unit includes a plurality of video connection ports for corresponding electronic devices to connect thereto, and at least one RS232 connection port for connecting to an RS232 connection port on one corresponding electronic device via an RS232 transmission cable.

15. The device for controlling and integrating multiple types of signal transmission cables as claimed in claim 12, wherein the multi-signal transmitter module further includes a second signal source unit and a differential signal selection unit; the second signal source unit including a plurality of second connection ports connected to a plurality of second transmission cables for receiving a plurality of third differential signals transmitted over the second transmission cables; the differential signal selection unit being connected to an end of the network cable and including a plurality of differential video positions and one differential instruction position; the differential instruction position being connected to the differential conversion unit for receiving and allowing the first differential signal to transmit therethrough; the differential video positions being connected to the second signal source unit, such that any one of the differential video positions can be enabled according to a third control instruction transmitted by the control unit for one of the third differential signals that corresponds to the enabled differential video position to pass the differential signal selection unit; and
wherein the first differential signal and the third differential signal are then sequentially received by the multi-signal receiver module.

16. The device for controlling and integrating multiple types of signal transmission cables as claimed in claim 15, wherein the multi-signal receiver module further includes a differential signal distribution unit, which has an end connected to another end of the network cable and has another end connected to the differential solution unit and another corresponding electronic device.

17. The device for controlling and integrating multiple types of signal transmission cables as claimed in claim 15, wherein the third differential signals can be LVDS (Low-voltage Differential Signaling) signals or TMDS (Transition Minimized Differential Signaling) signals.
